(19) United States
(12) Patent Application Publication
(10) Pub. No.: US 2005/0085651 A1
(43) Pub. Date: Apr. 21, 2005

(54) Crystal of N-long-chain acylglycine salt, method of production thereof, and detergent composition using said crystal

(75) Inventors: Nobuyoshi Kitamura, Kawasaki-shi (JP); Tatsuya Hattori, Kawasaki-shi (JP)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: AJINOMOTO CO., INC., Tokyo (JP)

(21) Appl. No.: 10/960,155

(22) Filed: Oct. 7, 2004

(30) Foreign Application Priority Data
Oct. 8, 2003 (JP) 350073/2003

(51) Int. Cl. C11B 1/00

(52) U.S. Cl. 554/1

(57) ABSTRACT

A crystal of an N-long-chain acylglycine salt represented by the formula (I): 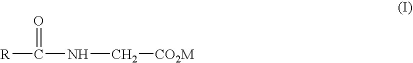 wherein R represents a linear or branched alkyl or alkenyl group having 7-21 carbon atoms; M represents an alkali metal or a basic amino acid, which produces diffraction peaks at positions of at least two diffraction angles (2θ±0.3°) selected from among 24.1°, 25.5°, 28.1° and 40.5° in powder X-ray diffraction analysis using Cu—Kα rays. The crystal of the N-long-chain acylglycine salt of the present invention is superior in the ease of handling, dissolution property and dispersibility in water.

### TECHNICAL FIELD OF THE INVENTION

The present invention relates to a crystal of an N-long-chain acylglycine salt, a method of production thereof, and a detergent composition containing said crystal or a milled product thereof.

### BACKGROUND OF THE INVENTION

Since N-long-chain acylglycine salts exhibit excellent surfactant action and bacteriostatic action and are of low irritating potential, they are used as ingredients of various detergent compositions.

As a method of producing an N-long-chain acylamino acid salt such as an N-long-chain acylglycine salt, the Schotten-Baumann reaction, wherein an amino acid and a fatty acid halide are condensed in an aqueous solution under alkaline conditions, is generally widely known. According to this method, by-products such as inorganic salts are produced along with the N-long-chain acylamino acid salt, which by-products affect dosage form stability when coming in the detergent composition; various attempts have been made to remove by-products such as inorganic salts from the acylation reaction solution. In particular, a method is conventionally used wherein a strong acid is added to the acylation reaction solution to cause double decomposition and a desalinized N-long-chain acylamino acid is collected (JP-A-5-70418). It is common practice to prepare an N-long-chain acylamino acid salt by reacting the thus-purified N-long-chain acylamino acid with a basic substance.

However, in such a reaction with water as the only solvent, the acylation reaction rate is at most a little over 90%, with a relatively large amount of fatty acids remaining unreacted. The remaining fatty acids occur as impurities in the N-long-chain acylamino acid, affecting the properties of the N-long-chain acylamino acid salt, and causing a problematic odor. Additionally, the manufacturing process is subject to limitation as to reaction equipment material because of a liquid nature change from strong alkalinity to strong acidity; other drawbacks include further purity reductions due to inadequate stirring associated with increased viscosity of the reaction solution.

As a modification of the Schotten-Baumann reaction which is particularly suitable for the production of N-long-chain acyl-α-alanine, a method has been reported wherein an N-long-chain acylalanine crystal is prepared at high purity and high percent yield with the precipitation of the intermediate potassium salt suppressed by using potassium hydroxide and choosing higher temperatures than the conventional method (JP-A-7-157795). It is not applicable to all kinds of N-long-chain acyl neutral amino acids, and is not always effective on some kinds of N-long-chain acyl neutral amino acids because of such drawbacks as insufficient crystallization and too much time taken for the water washing process. For example, when glycine was used as a raw material, the resulting acylglycine occurred as fine crystals difficult to separate by filtration, as far as experiments by the present inventors are concerned.

Other known methods include a method comprising reacting an amino acid and a fatty acid halide in a mixed solvent of water and a hydrophilic organic solvent, acidifying the resulting reaction solution with an inorganic acid, recovering the separating organic layer to yield a crude N-long-chain acylamino acid, then dissolving the crude N-long-chain acylamino acid in a recrystallization solvent, and obtaining a highly pure N-long-chain acylamino acid by cooling crystallization, and a method comprising neutralizing the thus-obtained crude N-long-chain acylamino acid with a basic substance to a degree of neutralization of 1 or lower, then dissolving the N-long-chain acylamino acid by the addition of a hydrophilic organic solvent such as acetone, and obtaining a highly pure N-long-chain acylamino acid salt by cooling crystallization (JP-A-2003-96038 and JP-A-2003-96039), as well as a method of producing an N-long-chain acyl acidic amino acid mono-alkali salt comprising reacting an acidic amino acid and a long-chain fatty acid halide in the presence of alkali, adjusting the reaction solution to pH 4-6 at 30-50° C., and cooling to 5-15° C. to crystallize the mono-alkali salt (JP-A-5-4952).

However, the production of an N-long-chain acylamino acid salt in JP-A-2003-96038 and JP-A-2003-96039 involves drawbacks, including process complexity and necessity for a reaction vessel of a material applicable to a broad range of pH, because the reaction solution containing an N-long-chain acylamino acid salt produced in the N-long-chain acylamino acid production process is acidified to obtain an N-long-chain acylamino acid, which acid is again alkalinized in the solution.

Also, the method of JP-A-5-4952 employs an acidic amino acid as a raw material and is not suitable for the obtainment of an N-long-chain acyl compound salt of a neutral amino acid like glycine.

Although it is a common practice to use an N-long-chain acylglycine salt produced as described above as a detergent ingredient of facial cleansing foams, facial cleansing powders, solid soaps and the like, after being taken out as a dry powder from a solution containing the salt using a spray dryer, a drum dryer and the like, and more finely milled as necessary, the productivity of the drying process may be poor with some chain length distributions to the extent of an economic disadvantage because the water solubility of the salt decreases as the acyl group chain length increases. Also, the dry powder obtained using the spray drier method poses a problem of dusting during the preparation and use of the detergent composition, and is not always sufficient in water dispersibility.

Accordingly, there is a need for an N-long-chain acylglycine salt of higher quality and greater ease of handling, and there is also a need for a method of its production which is not subject to limitation as to the material of reaction vessel, and which enables the production of the desired product via convenient procedures at high quality and high percent yields.

### SUMMARY OF THE INVENTION

The present invention has been developed in view of the circumstances described above, and the problems to be solved thereby are to provide a method of producing a highly pure N-long-chain acylamino acid salt conveniently and at high percent yields, and to provide a crystal excellently soluble and dispersible in water and a detergent composition containing said crystal.

The present inventors conducted extensive investigations in an attempt to solve the above problems and found that a highly pure N-long-chain acylglycine salt crystal could be obtained very conveniently at a high crystallization recovery rate, a high acylation purity, and a low inorganic salt content by reacting glycine and a fatty acid halide in a particular mixed solvent of a hydrophilic organic solvent and water in the presence of an alkali in a particular pH range to cause direct crystallization from the reaction solution of a particular mixed solvent ratio of the hydrophilic organic solvent and water. The inventors conducted further investigations based on this finding and developed the present invention.

Accordingly, the present invention relates to the following:

(1) A crystal of an N-long-chain acylglycine salt represented by the formula (I): 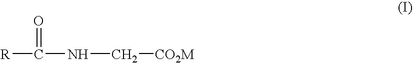
wherein R represents a linear or branched alkyl or alkenyl group having 7-21 carbon atoms; M represents an alkali metal or a basic amino acid, which produces diffraction peaks at positions of at least two diffraction angles (2θ±0.3°) selected from 24.1°, 25.5°, 28.1° and 40.5° in powder X-ray diffraction analysis using Cu—Kα rays.

(2) The crystal of (1) above, wherein the maximum diffraction peak in the 140-460 range appears at a diffraction angle (2θ±0.3°) within the range of 24.1°-28.1° in powder X-ray diffraction analysis using Cu—Kα rays.

(3) The crystal of (1) or (2) above, wherein the maximum diffraction peak in the 14°-46° range appears at a diffraction angle (2θ±0.3°) of 24.1° or 28.1° in powder X-ray diffraction analysis using Cu—Kα rays.

(4) The crystal of any of (1)-(3) above, wherein at least three of the four most intense diffraction peaks appearing in the 14°-46° range correspond to any of diffraction angles (2θ±0.3°) of 21.6°, 23.1°, 24.1°, 25.5°, 28.1°, 31.5° and 40.5° in powder X-ray diffraction analysis using Cu—Kα rays.

(5) The crystal of any of (1)-(4) above, wherein R is an alkyl group having 11-15 carbon atoms.

(6) The crystal of (1) or (2) above, wherein the alkali metal is sodium or potassium.

(7) A detergent composition comprising the crystal of any of (1)-(6) above, or a milled product thereof.

(8) A method of producing a crystal of an N-long-chain acylglycine salt, which comprises condensing glycine and a saturated or unsaturated fatty acid halide having 8-22 carbon atoms in a mixed solvent of a hydrophilic organic solvent and water with a hydrophilic organic solvent content of 5-30 wt %, in the presence of an alkali, at pH 9-13, then adjusting the N-long-chain acylglycine salt concentration in the reaction solution to 7-20 wt %, the hydrophilic organic solvent content to 3-75 wt %, and the pH to 7-11, and crystallizing an N-long-chain acylglycine salt from said reaction solution under cooling.

### BRIEF DESCRIPTION OF THE DRAWINGS

FIG. 1 shows a powder X-ray diffraction pattern with Cu—Kα rays of the N-lauroylglycine sodium salt obtained in Example 1.

FIG. 2 shows a powder X-ray diffraction pattern with Cu—Kα rays of the N-coconut oil glycine sodium salt obtained in Example 2.

FIG. 3 shows a powder X-ray diffraction pattern with Cu—Kα rays of the N-myristoylglycine sodium salt obtained in Example 3.

FIG. 4 shows a powder X-ray diffraction pattern with Cu—Kα rays of the N-palmitoylglycine sodium salt obtained in Example 6.

FIG. 5 shows a powder X-ray diffraction pattern with Cu—Kα rays of the N-coconut oil glycine sodium salt obtained in Comparative Example 2.

FIG. 6 shows a powder X-ray diffraction pattern with Cu—Kα rays of the N-lauroylglycine sodium salt obtained in Comparative Example 4.

### DETAILED DESCRIPTION OF THE INVENTION

The crystal of the N-long-chain acylglycine salt of the present invention (hereinafter to be also referred to as an N-long-chain acylglycine salt crystal) is better in the ease of handling and more dispersible and soluble than the powders obtained by conventional methods such as spray drying. Furthermore, said crystal can be milled to obtain desired particle sizes, and the powder obtained by milling the same is unlikely to scatter and excellent in dispersibility and solubility. Therefore, using said crystal or the powder obtained by milling the same where necessary as a raw material would be excellently effective in that not only the productivity for various detergent compositions is remarkably improved, but also the various detergent compositions obtained are excellent in dispersibility and solubility, and, in the case of a powder detergent, scattering is suppressed.

According to the production method of the present invention, moreover, an N-long-chain acylglycine salt, which has traditionally been produced via a painstaking process comprising acidifying the reaction solution to remove the salts and other by-products produced after the acylation reaction, isolating long-chain acylglycine, then reacting said long-chain acylglycine with a basic substance, can be produced conveniently at high acylation rates and high recovery rates in the form of highly pure crystals of low salt contents.

The present invention is hereinafter described in more detail.

The N-long-chain acylglycine salt crystal of the present invention is an N-long-chain acylglycine salt represented by the formula (I): 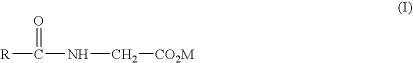
wherein R represents a linear or branched alkyl or alkenyl group having 7-21 carbon atoms; M represents an alkali metal or a basic amino acid), which produces diffraction peaks at positions of at least two or more diffraction angles (2θ±0.3°) selected from among 24.1°, 25.5°, 28.1° and 40.5° in powder X-ray diffraction analysis using Cu—Kα rays. From the viewpoint of remarkably high crystallinity, it is preferable that the maximum diffraction peak in the 14°-46° range appears at 24.1°-28.1° (2θ±0.3°) in powder X-ray diffraction analysis using Cu—Kα rays, and it is more preferable that the maximum diffraction peak appears at 24.1° or 28.1° (2θ±0.3°). Furthermore, it is more preferable that at least three of the four most intense diffraction peaks appearing in the 14°-46° range in powder X-ray diffraction analysis using Cu—Kα rays correspond to any one of 21.6°, 23.1°, 24.1°, 25.5°, 28.1°, 31.5° and 40.5° (2θ±0.3°), and it is most preferable that all of the three most intense diffraction peaks appearing in the 14°-46° range correspond to any one of 21.6°, 23.1°, 24.1°, 25.5°, 28.1°, 31.50 and 40.50 (2°±0.30).

Examples of the alkyl or alkenyl group having 7-21 carbon atoms represented by R in Formula (I) include a heptyl group, a nonyl group, a decyl group, a tridecyl group, a pentadecyl group, a heptadecyl group, a heptadecenyl group and the like, with preference given to those having 7-19, preferably 7-17, carbon atoms.

The N-long-chain acylglycine salt crystal of the present invention may be a salt of a compound of Formula (I) having a single acyl group for R—CO—, and may be a salt comprising a compound having a plurality of different kinds of acyl groups. Hence, an N-long-chain acylglycine salt crystal comprising a mixture of compounds with different acyl groups can be obtained using a mixed fatty acid halide such as a coconut oil fatty acid halide, a beef tallow fatty acid halide, a hardened beef tallow fatty acid halide, a castor oil fatty acid halide, an olive oil fatty acid halide or a palm oil fatty acid halide as the raw material fatty acid halide.

Referring to the N-long-chain acylglycine salt crystal of the present invention, the neutralizing base (M in Formula (I)) is exemplified by alkali metals (sodium, potassium, lithium and the like), basic amino acids (lysine, ornithine, arginine and the like) and the like. In particular, considering the crystallinity and versatility of the resulting salt, it is preferable that the alkali metal used be sodium or potassium, and that the basic amino acid used be lysine or arginine.

In the case of the N-long-chain acylglycine salt crystal produced using the aforementioned known method (hereinafter referred to as “type-A crystal”), the diffraction peaks obtained by powder X-ray diffraction (Cu—Kα rays) are weak in intensity and the maximum peaks appear at diffraction angles (2θ±0.3°) of 24.0° or lower (usually appear at positions of at least two diffraction angles (2θ±0.3°) of 21.5° and 23.4°), with no conspicuous diffraction peaks appearing at diffraction angles (2θ±0.3°) of 24.0°, 25.5°, 28.0° and 40.5°. In contrast, the N-long-chain acylglycine salt of the present invention (hereinafter referred to as “type-B crystal”) is highly crystalline and produces characteristic diffraction peaks at positions of at least two diffraction angles (2θ±0.3°) selected from among 24.0°, 25.5°, 28.0° and 40.5°, having a crystal form evidently differing from that of the known type-A crystal.

The N-long-chain acylglycine salt type-B crystal of the present invention is produced by condensing glycine and a saturated or unsaturated fatty acid halide having 8-22 carbon atoms in a mixed solvent of a hydrophilic organic solvent and water in the presence of an alkali, and crystallizing an N-long-chain acylglycine salt from the reaction solution, and is obtained as a highly pure crystalline acylglycine salt with a crystallization recovery rate of 96% or higher, an acylation purity of 98 wt % or higher, and an inorganic salt content of 2% or lower.

As described in the Examples and Comparative Examples given below, the N-long-chain acylglycine salt type-B crystal of the present invention provides a powder with water dispersibility and solubility and anti-dusting quality improved significantly compared to conventional products.

Referring to the production of the N-long-chain acylglycine salt type-B crystal of the present invention, the saturated or unsaturated fatty acid halide having 8-22 carbon atoms may be linear or branched, and is exemplified by simple-composition fatty acid halides such as caprylic halides, capric halides, lauric halides, myristic halides, palmitic halides, stearic halides and oleic halides; and mixed fatty acid halides such as coconut oil fatty acid halides, beef tallow fatty acid halides, hardened beef tallow fatty acid halides, castor oil fatty acid halides, olive oil fatty acid halides and palm oil fatty acid halides; with preference given to lauric halides, myristic halides and palmitic halides.

Examples of the hydrophilic organic solvent in the mixed solvent of water and a hydrophilic organic solvent as the reaction solvent include ketone-series solvents such as acetone, methyl ethyl ketone and cyclohexanone; nitrile-series solvents such as acetonitrile and propionitrile; alcohol-series solvents such as methanol, ethanol, isopropanol, s-butanol and t-butanol; and ether-series solvents such as dioxane and tetrahydrofuran. In particular, ketone-series solvents and alcohol-series solvents are preferred from the viewpoint of recyclability and the ease of crystallization. Particularly preferred are acetone, methyl ethyl ketone, isopropanol and t-butanol. These hydrophilic organic solvents may be used alone or in combination.

Examples of the alkali allowed to be present in the reaction solvent include alkali metal hydroxides such as sodium hydroxide and potassium hydroxide.

In the present invention, the alkali is allowed to be present in the reaction system so that the pH of the reaction system (in the reaction solvent) in the condensation reaction of glycine and a fatty acid halide is 9-13, preferably 9-11, more preferably 10-11. The alkali may be added in sequence so that the reaction solution pH is controlled at 9-13, preferably 9-11, more preferably 10-11, during the reaction of glycine and the fatty acid halide. Alternatively, the alkali in the previously calculated entire amount necessary for the reaction may be mixed with glycine and the reaction solvent at the time of charging the reaction materials, and the fatty acid halide is added to this mixed system.

It is preferable that the reaction temperature in the condensation reaction of glycine and the fatty acid halide be 5-60° C., more preferably in the range of 10-55° C. Reaction temperatures lower than 5° C. and those exceeding 60° C. are undesirable because of an increase in reaction solution viscosity to the extent of stirring inadequacy in the former case, and of a possible purity reduction in the latter case.

Also, the hydrophilic organic solvent content in the reaction solvent is 5-30 wt %, preferably about 10-20 wt %. Hydrophilic organic solvent contents lower than 5 wt % are undesirable because of an increase in reaction solution viscosity to the extent of difficulty in the reaction at high concentrations. On the other hand, even if the hydrophilic organic solvent content exceeds 30 wt %, it has substantially no effect on percent reaction yield and reaction solution viscosity; therefore, the hydrophilic organic solvent need not be used in amounts such that its content ratio exceeds 30 wt % during the condensation reaction.

It is recommended that the reaction concentration in the condensation reaction (acylation reaction) of glycine and the fatty acid halide be such that the N-long-chain acylglycine salt concentration in the reaction solution after completion of the acylation reaction will be 7-40 wt %, preferably 7-35 wt %. Specifically, taking into consideration the kind of fatty acid halide, kind of hydrophilic organic solvent, mixing ratio of water and hydrophilic organic solvent, kind of alkali, and the like, raw material compounds (glycine and fatty acid halide) and alkali quantity are determined so that the N-long-chain acylglycine salt concentration in the reaction solution after completion of the acylation reaction will be 7-40 wt %, preferably 7-35 wt %. Reaction concentrations lower than 7 wt % are economically disadvantageous; reaction concentrations exceeding 40 wt % increase reaction solution viscosity to the extent of an additional burden on the equipment and can cause a purity reduction, due to insufficient stirring, in the desired product N-long-chain acylglycine salt. As long as the reaction concentration is within the 7-40 wt % range, any precipitation of the N-long-chain acylglycine salt crystal during the reaction is not problematic at all.

Because the condensation reaction (acylation reaction) of glycine and the fatty acid halide proceeds at a nearly constant molar ratio using the solvent system of this reaction, the molar ratio of glycine and the fatty acid halide may usually be 1:1; however, depending on the fatty acid halide and solvent system used, either of glycine and the fatty acid halide may be present in excess, in consideration of percent yield and economy. For this reason, the acylation reaction rate of this reaction is shown in terms of fatty acid halide conversion rate.

After the acylation reaction, the reaction solution is cooled to precipitate the N-long-chain acylglycine salt type-B crystal. In this crystallization process, the N-long-chain acylglycine salt concentration in the reaction solution is not subject to limitation, as long as the slurry (the reaction solution) can be stirred at the time of completion of the crystallization process, but is preferably 7-20 wt %, more preferably 7-15 wt %. Concentrations exceeding 20 wt % are undesirable because stirring during the crystallization process is sometimes impossible. If the concentration of the desired product (N-long-chain acylglycine salt) in the reaction solution exceeds 20 wt %, it is preferable that the concentration of the desired product (N-long-chain acylglycine salt) be lowered by adding water or a mixed liquid of water and a hydrophilic organic solvent to the reaction solution. Concentrations of the desired product lower than 7 wt % are economically disadvantageous and hence undesirable.

The hydrophilic organic solvent added supplementarily for concentration adjustment in the crystallization process may be the same as, or different from, the solvent used in the acylation process. For example, ketone-series solvents such as acetone, methyl ethyl ketone and cyclohexanone; nitrile-series solvents such as acetonitrile and propionitrile; alcohol-series solvents such as methanol, ethanol, isopropanol, s-butanol and t-butanol; ether-series solvents such as dioxane and tetrahydrofuran; and the like can be mentioned. In particular, ketone-series solvents and alcohol-series solvents are preferred from the viewpoint of recyclability and the ease of crystallization. Particularly preferred are acetone, methyl ethyl ketone, isopropanol and t-butanol. These hydrophilic organic solvents may be used singly or in combination.

In the crystallization process, the hydrophilic organic solvent content in the reaction solution is 3-75 wt %, particularly preferably about 3-65 wt %. Hydrophilic organic solvent contents above or below this range can cause recovery rate reductions or hamper the separation of crystal.

In the method of the present invention, it is unlikely that by-products such as fatty acids come in the crystal during N-long-chain acylglycine salt crystallization because crystallization is conducted using a mixed solvent system of an organic solvent and water, and by-products such as inorganic salts can be removed by washing; therefore, an N-long-chain acylglycine salt of high quality can be obtained despite the direct collection of the desired product from the reaction solution without involving the acid form.

The final cooling temperature for the reaction solution in the crystallization process varies depending on the kind of fatty acid halide, kind of hydrophilic organic solvent, mixing ratio of hydrophilic organic solvent and water, and other factors, and is preferably −5° C.-30° C., more preferably 0° C.-20° C. It is preferable that the pH of the reaction solution be 7 or higher, preferably in the range of 7-11. pH values lower than 7 are undesirable because N-long-chain acylglycine precipitates to the extent of difficulty in solid-liquid separation.

The N-long-chain acylglycine salt type-B crystal of the present invention may be a basic amino acid salt. To obtain the N-long-chain acylglycine salt type-B crystal of the present invention comprising a basic amino acid, glycine is acylated using an alkali metal hydroxide, after which a basic amino acid or a hydrochloride thereof is added to the reaction solution and the reaction solution is cooled, with pH adjusted where necessary, to crystallize the basic amino acid salt of N-long-chain acylglycine. The amino acid used is usually a basic amino acid, whether naturally occurring or not, and may be of any of the L-configuration, D-configuration and DL-configuration. Considering the stability and description of the resulting salt, arginine and lysine are particularly preferred.

In the present invention, the N-long-chain acylglycine salt crystal precipitated from the reaction solution can be separated and recovered by an ordinary method, for example, filtration under reduced or increased pressure, centrifugation and the like. Because the recovered product contains inorganic salts and organic solvents produced as by-products during the acylation reaction and pH adjustment, it is preferable that the recovered product be washed with water, a mixed of water and a hydrophilic organic solvent, or a salt solution of a concentration less than 5% as necessary. In this case, it is preferable that the temperature of the liquid (washing solution) be not higher than the crystallization temperature. The term “salt solution” as used herein refers to an aqueous solution wherein inorganic salts produced as by-products in the reaction and crystallization processes are dissolved.

As described above, the method of the present invention enables the continuous obtainment of an N-long-chain acylglycine salt directly from the reaction solution after the acylation reaction, and is therefore very convenient compared to the conventional method, which involves the acid form; in addition, an N-long-chain acylglycine salt crystal can be obtained as a highly pure product with a crystallization recovery rate of 96% or higher, an acylation purity of 98 wt % or higher, and an inorganic salt content of 2% or lower.

It is preferable that the N-long-chain acylglycine salt type-B crystal of the present invention be used after being appropriately milled [its particles classified (sieved) where necessary] depending on the manner of use thereof. Milling and particle classification can be conducted using means and methods known per se.

The N-long-chain acylglycine salt type-B crystal of the present invention can be used as a detergent ingredient of various detergent compositions containing other ingredients (e.g., a carrier).

Detergent compositions to which the present invention is applicable include shampoos, rinse-in-shampoos, conditioning shampoos, facial cleansing agents, makeup removers, facial cleansing foams, facial cleansing powders, cleansing lotions, cleansing creams, hand soaps, solid soaps, oral cavity cleansing agents, shaving foams and body shampoos.

Detergent compositions to which the present invention is applicable may be formulated with ingredients conventionally used with detergents, such as oils, surfactants, thickening agents, antiseptics, flavoring agents, ultraviolet absorbents, moisturizing agents, bioactive ingredients, antioxidants, anti-inflammatory agents, antibacterial agents, antiperspirants, chelating agents, neutralizing agents and pH regulators, according to the specific use and dosage form of the detergent.

Characteristics (properties) described herein were determined using the methods shown below.

[Powder X-Ray Diffraction Analysis Using Cu—Kα Rays]

In powder X-ray diffraction analysis using Cu—Kα rays, measurements were taken using a powder X-ray diffraction apparatus (X'pert) manufactured by PANalytical under conditions involving a counter-cathode Cu—Kα (1.5405 Å), a 40 KV voltage, a 55 mA amperage, a 0.020° sampling width, a 3.0°/min scanning speed, and a 10-50° measurement diffraction angle range (2θ). Peak search was conducted using the peak search function of the software attached to the diffraction apparatus under the conditions “minimum significance=1.00, minimum peak tip 0.010, maximum peak tip=1.00°, peak base width=2.00°, method=minimum value of secondary differential.”

[Determination of Average Particle Diameter]

Using the GILSONIC AUTOSIEVER (GA-6, manufactured by GILSON), an about 2 g coarsely milled sample (pass through 425μ mesh) was sieved for 5 minutes and the resulting particles were classified by size; the average particle diameter was calculated from the weights of particles in respective classes.

[Calculation of Crystallization Recovery Rate]

On the basis of the acylglycine salt weight in the acylation reaction solution, determined by high performance liquid chromatography, the crystallization recovery rate was calculated using the equation below.
Equation for calculating the crystallization recovery rate Crystallization recovery rate (%)=[crystal weight/(reaction solution weight×reaction solution acylglycine salt concentration)]×100
[Determination of Acylation Purity]

Measurements were taken using high performance liquid chromatography (column: YMC-PACK A-312, temperature: 40° C., eluent: CH₃OH/30 mM NaH₂PO₄ (pH=3)=77/23-84/16, detection: 210 nm), and the acylation purity in the crystal or powder was calculated from the acylglycine weight and fatty acid weight using the equation below.
Equation for Calculating Acylation Purity

$$\begin{matrix}Acylation purity ( \% ) = [ acylglycine weight / ( acylglycine weight + \\ fatty acid weight ) ] \times 100\end{matrix}$$

[Determination of Inorganic Salt Content]

Measurements were taken using the Dionex DX-100 ion chromatograph (columns: AG11-HC-2 mm and AS11-HC-2 mm, temperature: 40° C., eluent: 30 mM NaOH, regeneration fluid: 0.01N sulfuric acid). The inorganic salt content in the crystal or powder was calculated from the abundance of Cl and SO₄ converted to NaCl, KCl and Na₂SO₄.

### EXAMPLES

The present invention is hereinafter described in more detail by means of the following working examples and comparative examples, which examples, however, are not to be construed as limiting the present invention.

### Example 1

### Production of N-lauroylglycine Sodium Salt

Glycine (30.0 g) was dissolved in 130 g of water, 30.6 g of acetone (organic solvent content: 19.1 wt %) and 8.2 g of sodium hydroxide to obtain an aqueous solution of pH 10. Subsequently, 87.4 g of lauroyl chloride and a 27% aqueous solution of sodium hydroxide were added to this solution over about 1 hour, while maintaining a pH of 10. During this treatment, the reaction temperature was kept at 25° C. Addition of the acid chloride was followed by stirring at constant temperature for about 1 hour to yield 368.3 g of a reaction solution. The obtained reaction solution was analyzed by high performance liquid chromatography and found to contain about 30.0% of N-lauroylglycine sodium. The acylation reaction rate was 97%. An equal amount of a 33% aqueous solution of acetone was added to 150 g of the reaction solution, and the mixture was heated to 40° C. (the acylglycine salt concentration in the resulting diluted solution was about 15 wt %, the organic solvent content was 20.6 wt %, and the pH was 9.8). This diluted solution was kept at 16° C. for several hours, after which it was cooled to 5° C. The precipitating crystal was centrifuged and dried to yield 43.6 g (crystallization recovery rate: 97%) of crystal.

The major peaks (20) of powder X-ray diffraction of this crystal are 10.4, 13.9, 21.5, 23.3, 23.4, 24.1, 24.5, 25.6, 28.0, 31.6, 42.6 and 46.3.

### Example 2

### Production of N-Coconut Oil Fatty Acid Acylglycine Sodium Salt

Glycine (30.0 g) was dissolved in 136 g of water, 30.8 g of acetone (organic solvent content: 18.5 wt %) and 8.6 g of sodium hydroxide to obtain an aqueous solution of pH 10. Subsequently, 87.9 g of coconut oil fatty acid chloride and a 27% aqueous solution of sodium hydroxide were added to this solution over about 1 hour, while maintaining a pH of 10. During this treatment, the reaction temperature was kept at 25° C. Addition of the acid chloride was followed by stirring at constant temperature for about 1 hour to yield 385.2 g of a reaction solution. The obtained reaction solution was analyzed by high performance liquid chromatography and found to contain about 28.5% of N-coconut oil fatty acid acylglycine sodium. The acylation reaction rate was 97%. An equal amount of a 50% aqueous solution of acetone was added to 150 g of the reaction solution and the mixture was heated to 30° C. (the acylglycine salt concentration in the diluted solution was about 14.3 wt %, the organic solvent content was 29.0 wt %, and the pH was 9.4). This diluted solution was kept at 20° C. for several hours, after which it was cooled to 5° C. The precipitating crystal was centrifuged and dried to yield 41.5 g (crystallization recovery rate: 97%) of a crystal.

The major peaks (20) of powder X-ray diffraction of this crystal are 10.2, 19.5, 23.1, 24.1, 25.7, 28.2, 30.9, 31.7, 33.6, 39.0 and 41.4.

### Example 3

### Production of N-myristoylglycine Sodium Salt—1

30.0 g of glycine was dissolved in 230.5 g of water, 37.5 g of isopropanol (organic solvent content: 14.0 wt %) and 9.5 g of sodium hydroxide to obtain an aqueous solution of pH 10. Myristoyl chloride (98.6 g) and a 27% aqueous solution of sodium hydroxide were added to this solution over about 1 hour, while maintaining a pH of 10. During this treatment, the reaction temperature was kept at 25-30° C. Addition of the acid chloride was followed by stirring at constant temperature for about 1 hour to yield 482 g of a reaction solution. The obtained reaction solution was analyzed by high performance liquid chromatography and found to contain about 25.0% of N-myristoylglycine sodium. The acylation reaction rate was 98%. An equal amount of water was added to 200 g of the reaction solution and the mixture was heated to 40° C. (the acylglycine salt concentration in the resulting diluted solution was about 12.5 wt %, the organic solvent content was 3.9 wt %, and the pH was 9.4). This diluted solution was kept at 26° C. for 2 hours, after which it was cooled to 5° C. The precipitating crystal was centrifuged and dried to yield 49.6 g (crystallization recovery rate: 99%) of a crystal.

The major peaks (20) of powder X-ray diffraction of this crystal are 15.6, 21.4, 21.9, 23.3, 24.1, 25.0, 28.2, 31.4 and 44.6.

### Example 4

### Production of N-myristoylglycine Sodium Salt —2

An equal amount of 2% isopropanol was added to 280 g of a reaction solution (acylation reaction rate: 98%) obtained in the same manner as in Example 3 and the mixture was heated to 40° C. (the acylglycine salt concentration in the resulting diluted solution was about 12.5 wt %, the organic solvent content was 4.9 wt %, and the pH was 9.5). This diluted solution was kept at 29° C. for 2 hours, after which it was cooled to 5° C. The precipitating crystal was centrifuged, then washed and separated with 80 g of 1% saline, after which it was dried to yield 67.2 g (crystallization recovery rate: 96%) of a crystal.

The major peaks (20) of powder X-ray diffraction of this crystal were the same as reported in Example 3.

### Example 5

### Production of N-myristoylglycine Potassium Salt

Glycine (30.0 g) was dissolved in 220.5 g of water, 37.5 g of acetone (organic solvent content: 14.5 wt %) and 14.9 g of potassium hydroxide to yield a solution of pH 10. Myristoyl chloride (98.6 g) and a 48% aqueous solution of potassium hydroxide were added to this solution over about 2 hours, while maintaining a pH of 10. During this treatment, the reaction temperature was kept at 25-40° C. Addition of the acid chloride was followed by stirring at constant temperature for about 1 hour to yield 450 g of a reaction solution. The obtained reaction solution was analyzed by high performance liquid chromatography and found to contain about 27.9% of N-myristoylglycine potassium. The acylation reaction rate was not lower than 98%. A 60% aqueous solution (350 g) of acetone was added to 200 g of the reaction solution and the mixture was heated to 40° C. (the acylglycine salt concentration in the resulting diluted solution was about 10.1 wt %, the organic solvent content was 41.2 wt %, and the pH was 9.4). This diluted solution was kept at 23° C. for 2 hours, after which it was cooled to 5° C. The precipitating crystal was centrifuged and dried to yield 54.7 g (crystallization recovery rate: 98%) of a crystal.

The major peaks (20) of powder X-ray diffraction of this crystal are 21.3, 23.4, 28.3 and 40.5.

### Example 6

### Production of N-palmitoylglycine Sodium Salt

30.0 g of glycine was dissolved in 250 g of water, 55 g of t-butanol (organic solvent content: 18.0 wt %) and 9.7 g of sodium hydroxide to obtain an aqueous solution of pH 10. Subsequently, 109.8 g of palmitoyl chloride and a 27% aqueous solution of sodium hydroxide were added to this solution over about 1 hour, while maintaining a pH of 10. During this treatment, the reaction temperature was kept at 25-30° C. Addition of the acid chloride was followed by stirring at constant temperature for about 1 hour to yield 531 g of a reaction solution. The obtained reaction solution was analyzed by high performance liquid chromatography and found to contain about 24.9% of N-palmitoylglycine sodium. The acylation reaction rate was 97%. An equal amount of water was added to 200 g of the reaction solution and the mixture was heated to 50° C. (the acylglycine salt concentration in the resulting diluted solution was about 12.5 wt %, the organic solvent content was 5.2 wt %, and the pH was 9.5). This diluted solution was kept at 34° C. for several hours, after which it was cooled to 10° C. The precipitating crystal was centrifuged and dried to yield 48.8 g (crystallization recovery rate: 98%) of a crystal.

The major peaks (2θ) of powder X-ray diffraction of this crystal are 14.1, 16.9, 19.7, 21,2, 21,8, 23.2, 24.0, 24.9, 25.5, 26.4, 28.3, 31.3, 40.2 and 46.2.

### Example 7

### Production of N-lauroylglycine Arginine Salt

A 15% aqueous solution (300 g) of acetone and 45.3 g of arginine hydrochloride were added to 200 g of a reaction solution (acylation reaction rate: 97%) obtained in the same manner as in Example 1. This diluted solution (the acylglycine salt concentration in this diluted solution was about 18.5 wt %, the organic solvent content was 12.2 wt %, and the pH was 7.1) was cooled to 5° C. The precipitating crystal was centrifuged and dried to yield 88.9 g (crystallization recovery rate: 96%) of a crystal.

The major peaks (2θ) of powder X-ray diffraction of this crystal are 10.4, 13.8, 21.4, 23.3, 24.0, 24.4, 25.5, 27.9 and 31.5.

### Comparative Example 1

### Production of N-myristoylglycine Salt in Water Solvent

Glycine (18.2 g) was dissolved in 362.3 g of water and 5.7 g of sodium hydroxide to yield a solution of pH 10. Myristoyl chloride (59.7 g) and a 27% aqueous solution of sodium hydroxide were added to this solution over an about 1 hour, while maintaining a pH of 10. The reaction temperature then was kept at 30-60° C. to avoid thickening. Addition of the acid chloride was followed by stirring at constant temperature for about 1 hour to yield 502 g of a reaction solution. The obtained reaction solution was analyzed by high performance liquid chromatography and found to contain about 12.3% of N-myristoylglycine sodium. The acylation reaction rate was 82.3%. This reaction solution was highly viscous, and the desired salt was inseparable due to precipitation of fine crystals.

### Comparative Example 2

### Production of N-Coconut Oil Fatty Acid Acylglycine Sodium Salt by Spray Drying

A reaction was carried out in the same manner as in Example 2. A 75% aqueous solution (30.5 g) of sulfuric acid was added to the obtained reaction solution to adjust its pH to 1.8, and the mixture was heated to 70° C. When the solution was stirred for 15 minutes and allowed to stand, it separated into an organic layer and an aqueous layer in several minutes. This organic layer was neutralized to pH 8.3 by the addition of 27% sodium hydroxide to yield an N-coconut oil fatty acid acylglycine sodium solution, which was concentrated under reduced pressure to distill off the acetone. The obtained distillate was diluted with water to obtain an N-coconut oil fatty acid acylglycine sodium concentration of 30%. This diluted solution was spray-dried to yield a powder of N-coconut oil fatty acid acylglycine sodium salt.

The major peaks (2θ) of powder X-ray diffraction of this powder are 19.3, 20.1, 21.4, 23.5, 25.0, 26.4 and 31.7.

### Comparative Example 3

### Production of N-Coconut Oil Fatty Acid Acylglycine Sodium Salt in Water Solvent by Spray Drying

Glycine (30.0 g) was dissolved in 230 g of water and 9.5 g of sodium hydroxide to adjust its pH to 10. Subsequently, 87.6 g of coconut oil fatty acid chloride was added to this solution over about 1 hour, while maintaining a pH of 10 using a 27% aqueous solution of sodium hydroxide. During this treatment, the reaction temperature was gradually increased from 25° C. with the addition of the acid chloride. After addition of the acid chloride, the reaction temperature was 50° C. This was followed by stirring at constant temperature for about 1 hour. The obtained reaction solution (435 g) was found to contain about 22% of N-coconut oil fatty acid acylglycine. The acylation reaction rate was 92%. Water (130 g) was added to this reaction solution to adjust to an N-coconut oil fatty acid acylglycine concentration of about 17%. After 31 g of a 75% aqueous solution of sulfuric acid was added, the resulting diluted solution was heated to 75° C. and stirred for 15 minutes. The diluted solution was then allowed to stand for 30 minutes; 139 g of the aqueous layer portion was removed, though the organic layer remained in an emulsified state. After 139 g of water was added, the residue was heated to 80° C., then stirred for 15 minutes. This solution was allowed to stand for 15 minutes; an organic layer separated as an oily layer. The aqueous layer (371 g) was removed; 225 g of the obtained organic layer was neutralized to pH 8.3 with 27% sodium hydroxide. Subsequently, 345 g of an N-coconut oil fatty acid acylglycine sodium solution having an adjusted concentration of 30% was obtained. This N-coconut oil fatty acid acylglycine sodium solution was spray-dried to yield a powder of N-coconut oil fatty acid acylglycine sodium salt.

The major peaks (2θ) of powder X-ray diffraction of this powder are 19.3, 20.0, 21.3 and 23.2.

### Comparative Example 4

### Production of N-lauroylglycine Sodium Salt by Freeze-Drying

A reaction was carried out in the same manner as in Example 1. A 75% aqueous solution (33.2 g) of sulfuric acid was added to the obtained reaction solution to adjust its pH to 1.8, and the mixture was heated to 70° C. When the solution was stirred for 15 minutes and allowed to stand, it separated into an organic layer and an aqueous layer in several minutes. This organic layer was neutralized to pH 8.3 by the addition of 27% sodium hydroxide to yield an N-lauroylglycine sodium solution, which was concentrated under reduced pressure to distill off the acetone. The obtained distillate was diluted with water to obtain an N-lauroylglycine sodium concentration of 30%. This N-lauroylglycine sodium solution was freeze-dried to yield a solid of N-lauroylglycine sodium salt.

The major peaks (20) of powder X-ray diffraction of this powder are 20.4, 20.9, 21.6 and 22.8.

Table 1 below shows the crystallization recovery rates, acylation purities (post-crystallization purities for Examples 1-7), inorganic salt contents and X-ray diffraction angles (in the order of intensity within the 14°-46° range) of the N-long-chain acylglycine salt crystals or powders obtained in Examples 1-7 and Comparative Examples 2-4 above.

TABLE 1

| | Crystal- | | | | | | |
|---|---|---|---|---|---|---|---|
| | lization | Acyla- | inorganic | | | | |
| | diffrac- | tion | salt | Maximum X-ray diffraction | | | |
| | tion | purity | content | angle | | | |
| | rate (%) | (%) | (%) | first | second | third | fourth |
| Ex. 1 | 97 | ≧98 | 1.2 | 24.1 | 31.6 | 28.0 | 21.5 |
| Ex. 2 | 97 | ≧98 | 1.1 | 28.2 | 25.7 | 23.1 | 30.9 |
| Ex. 3 | 99 | ≧98 | 1.1 | 24.1 | 28.2 | 21.9 | 31.4 |
| Ex. 4 | 96 | ≧98 | 0.2 | 24.1 | 28.2 | 21.9 | 31.4 |
| Ex. 5 | 98 | ≧98 | 1.7 | 28.3 | 21.3 | 40.5 | 23.4 |
| Ex. 6 | 98 | ≧98 | 0.9 | 24.0 | 25.5 | 31.3 | 28.3 |
| Ex. 7 | 96 | ≧98 | 1.9 | 24.0 | 24.4 | 31.5 | 27.9 |
| Com. | — | 97 | 1.6 | 21.4 | 23.5 | 20.1 | 19.3 |
| Ex. 2 | | | | | | | |
| Com. | — | 92 | 4.6 | 21.3 | 23.2 | 20.0 | 19.3 |
| Ex. 3 | | | | | | | |
| Com. | — | 97 | 2.5 | 21.6 | 20.9 | 20.4 | 22.8 |
| Ex. 4 | | | | | | | |

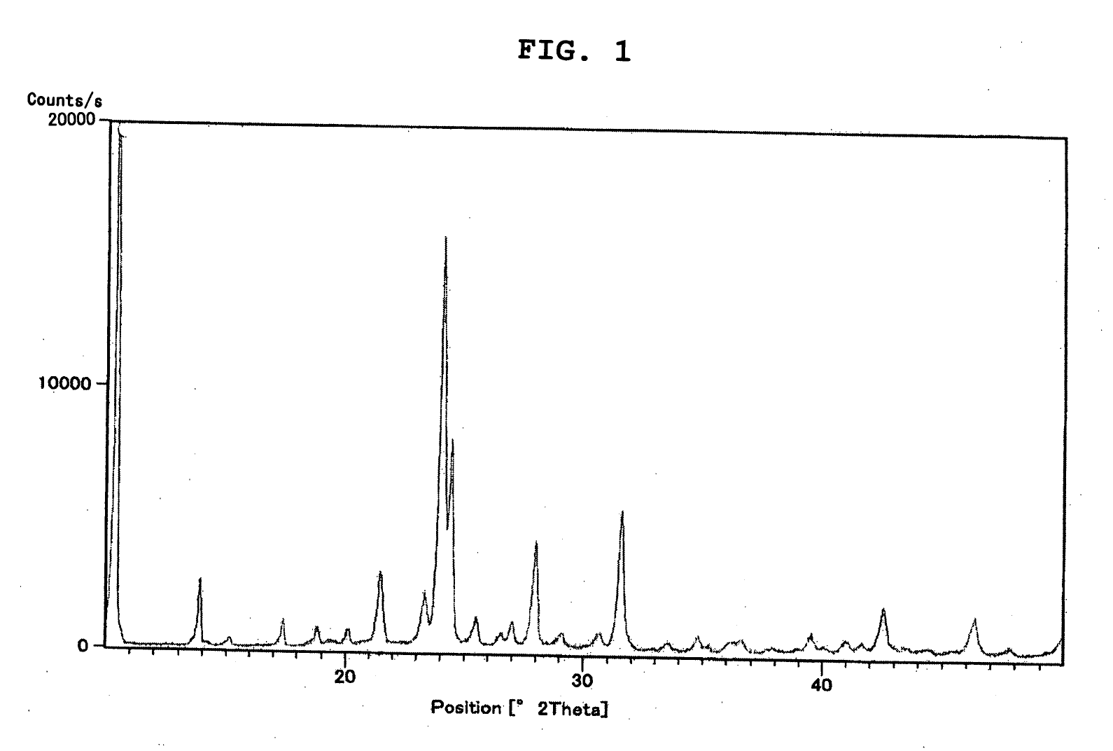

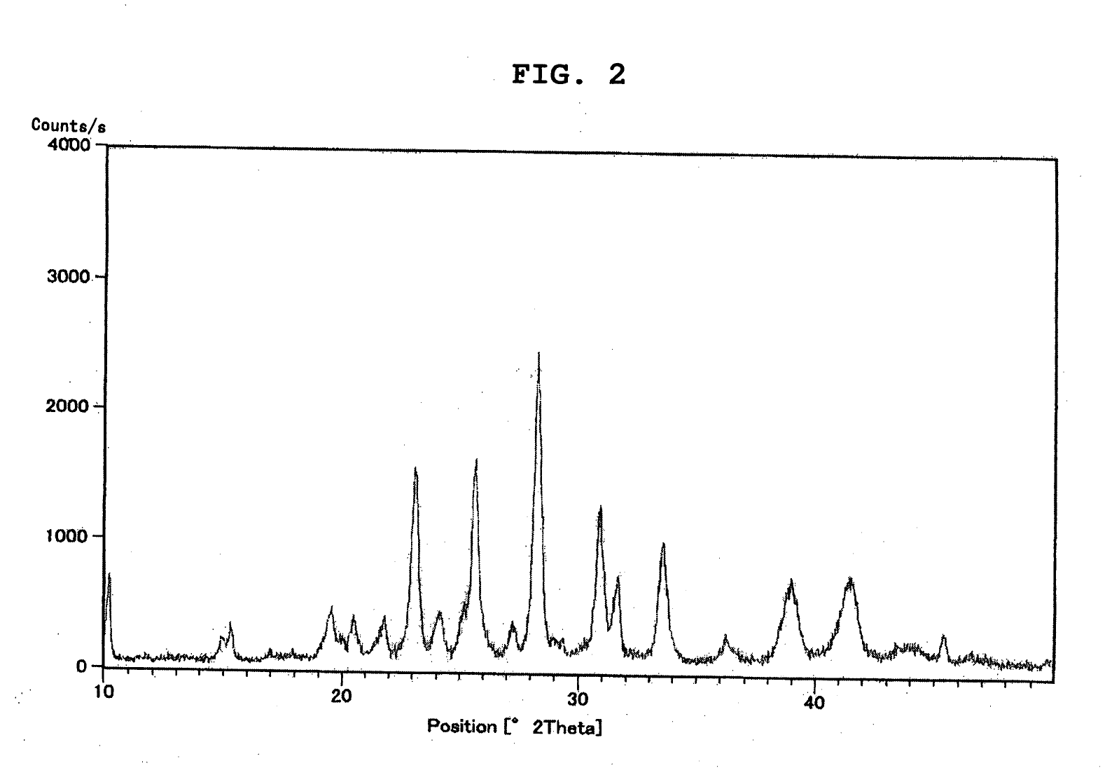

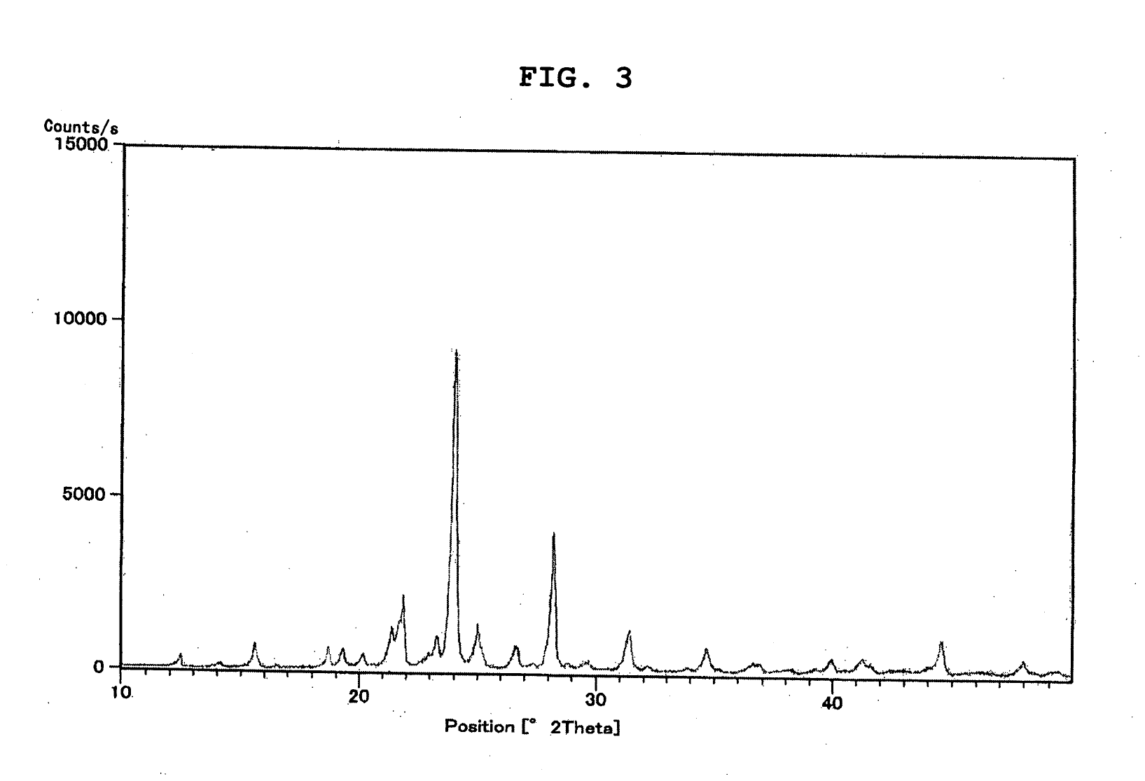

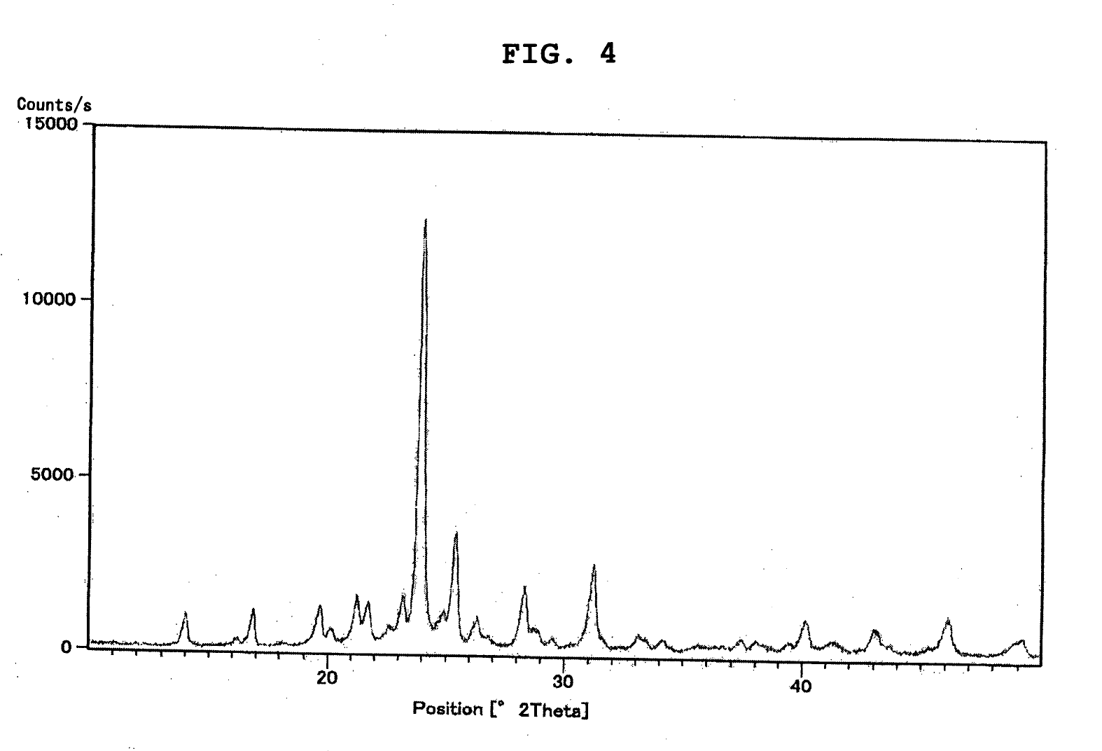

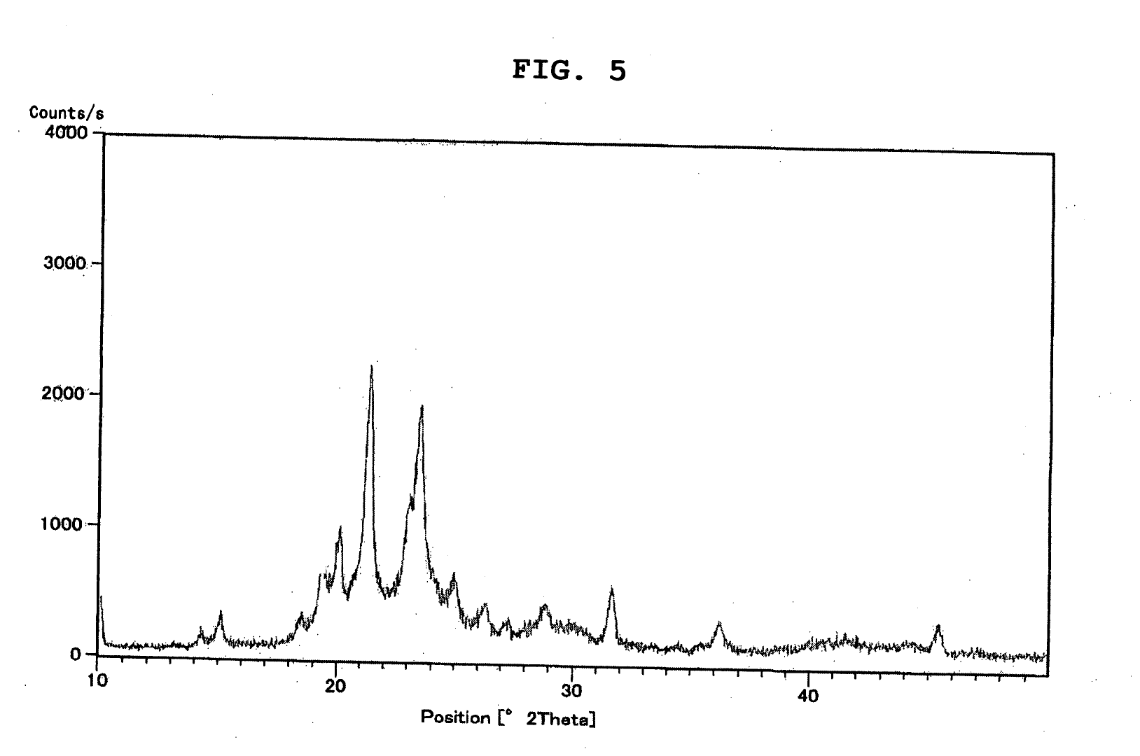

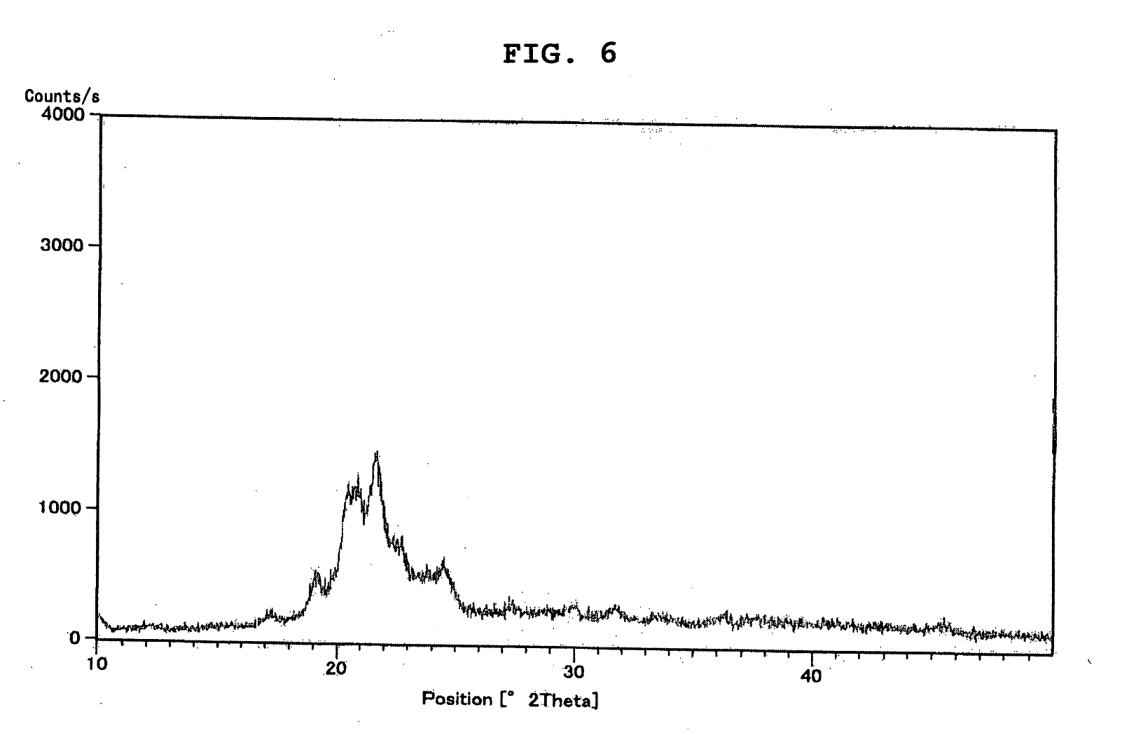

In addition, FIGS. 1-6 are powder X-ray diffraction patterns of the N-long-chain acylglycine salts obtained in Examples 1-3 and 6 and Comparative Examples 2 and 4.

All the N-acylglycine salts obtained by crystallization in Examples 1-7 produced diffraction peaks at positions of at least two or more diffraction angles (2θ±0.3°) selected from among 24.0°, 25.5°, 28.0° and 40.5°, whereas the N-acylglycine salts obtained in Comparative Examples 2-4 did not produce a diffraction peak at any of the above-mentioned four different diffraction angles. Hence, the N-acylglycine salt type-B crystal produced using the method of the present invention was found to have a crystal form clearly distinguishable from that of the known N-acylglycine salt.

The milled products of the crystals obtained in Examples 1-3 and the powder obtained in Comparative Example 2 were examined for dusting (scattering) and water solubility and dispersibility. Also, these powders were sieved and their average particle diameters were determined. The results are shown in Table 2.

TABLE 2

| | Average | | | |
|---|---|---|---|---|
| | particle | | | |
| | size | Dissolution | | |
| | (μm) | rate (sec) | Scattering | Dispersibility |
| Ex. 1 | 85 | 209 | 0.38 | ◯ |
| | 20 | 341 | 0.87 | ◯ |
| Ex. 2 | 87 | 139 | 0.66 | ◯ |
| Ex. 3 | 87 | 236 | 0.58 | ◯ |
| Com. | 18 | 716 | 1 | X |
| Ex. 2 | | | | |

As is evident from Table 2, the powders of N-acylglycine salt type-B crystal obtained in Examples 1 through 3 were found to surpass the powder of N-acylglycine salt obtained in Comparative Example 2 in terms of water solubility, water dispersibility, and anti-dusting quality (anti-scattering quality).

In this test, solubility is defined as time taken to dissolve 1.5 g of powder in 100 g of water at 30° C.

Scattering was quantified as described below. A 5 g powder sample was dropped by a distance of 1.2 m from the top of a cylinder (diameter: 12.5 cm). Two seconds after the drop, the scattered powder was sucked from the inlet in the base of the cylinder for 6 seconds using a blower; the powder caught by filter paper (GB100R, manufactured by Advantest Corporation) on the blower surface was weighed. This weight was expressed as a relative ratio to the powder weight in Comparative Example 2.

Dispersibility was evaluated by five panelists. A 1-gram powder sample was placed in the palm of each panelist and rubbed and examined for lumping in the presence of a small amount of water. Findings were evaluated using a three-grade rating system: good (O) for no lumping, acceptable (Δ) for a small amount of lumping, and poor (x) for a large amount of lumping.

Formulation Example: Facial Cleansing Foam

The ingredients shown in Table 3 below were dissolved at 70-80° C. and this solution was crystallized under cooling to room temperature to yield a facial cleansing foam having the composition (% by weight, total content: 100%) shown in the right column of Table 3 below. During this manufacturing, quick dissolution was achieved without dusting. This product was almost odorless and produced rich and fine foams. After being used for facial cleansing, the product provided a refreshing feeling.

TABLE 3

| | |
|---|---|
| Glycerine | 34.0 |
| Sodium lauroylglycinate (Example 1) | 10.0 |
| Sodium myristoylglycinate (Example 3) | 5.0 |
| Lauric acid | 0.6 |
| Myristic acid | 0.6 |
| Stearic acid | 1.0 |
| Monosodium stearoylglutamate | 0.5 |
| Distearoyl glycol | 1.0 |
| Cocamide propyl betaine | 3.0 |
| Polyquartanium-39 | 2.0 |
| Citric acid | 0.4 |
| Water | rest |
| Total | 100.0 |

The production method of the present invention is highly advantageous in that N-long-chain acylglycine salts, which have traditionally been produced via a painstaking process comprising acidifying the reaction solution to the remove salts and other by-products produced after the acylation reaction, isolating long-chain acylglycine, then reacting said long-chain acylglycine with a basic substance, can be produced conveniently at high acylation rates and high recovery rates in the form of highly pure crystals of low salt contents. Additionally, the N-long-chain acylglycine salt type-B crystal obtained using this method can be milled to desired particle sizes, and its milled product is less likely to scatter and hence better in the ease of handling than the powders obtained by conventional methods such as spray drying. The crystal obtained according to the present invention is also highly advantageous as a raw material for various detergent compositions because it is excellently dispersible and soluble in water.

This application is based on a patent application No. 350073/2003 filed in Japan, the contents of which are hereby incorporated by reference.

1. A crystal of an N-long-chain acylglycine salt represented by the formula (I): 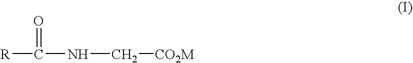
wherein R represents a linear or branched alkyl or alkenyl group having 7-21 carbon atoms; M represents an alkali metal or a basic amino acid, which produces diffraction peaks at positions of at least two diffraction angles (2θ±0.3°) selected from the group consisting of 24.1°, 25.5°, 28.1° and 40.5° in powder X-ray diffraction analysis using Cu—Kα rays.

2. The crystal of claim 1, wherein the maximum diffraction peak in the 14°-46° range appears at a diffraction angle (2θ±0.3°) within the range of 24.1°-28.1° in powder X-ray diffraction analysis using Cu—Kα rays.

3. The crystal of claim 1, wherein the maximum diffraction peak in the 14°-46° range appears at a diffraction angle (2θ±0.3°) of 24.1° or 28.1° in powder X-ray diffraction analysis using Cu—Kα rays.

4. The crystal of claim 1, wherein at least three of the four most intense diffraction peaks appearing in the 14°-46° range correspond to diffraction angles (2θ±0.3°) selected from the group consisting of 21.6°, 23.1°, 24.1°, 25.5°, 28.1°, 31.5° and 40.5° in powder X-ray diffraction analysis using Cu—Kα rays.

5. The crystal of claim 1, wherein R is an alkyl group having 11-15 carbon atoms.

6. The crystal of claim 2, wherein R is an alkyl group having 11-15 carbon atoms.

7. The crystal of claim 3, wherein R is an alkyl group having 11-15 carbon atoms.

8. The crystal of claim 4, wherein R is an alkyl group having 11-15 carbon atoms.

9. The crystal of claim 1, wherein M is sodium or potassium.

10. The crystal of claim 2, wherein M is sodium or potassium.

11. The crystal of claim 3, wherein M is sodium or potassium.

12. The crystal of claim 4, wherein M is sodium or potassium.

13. The crystal of claim 5, wherein M is sodium or potassium.

14. The crystal of claim 1, wherein M is lysine, ornithine, or arginine.

15. The crystal of claim 2, wherein M is lysine, ornithine, or arginine.

16. The crystal of claim 3, wherein M is lysine, ornithine, or arginine.

17. The crystal of claim 4, wherein M is lysine, ornithine, or arginine.

18. The crystal of claim 5, wherein M is lysine, ornithine, or arginine.

19. A detergent composition comprising the crystal of any of claims 1-18, or a milled product thereof.

20. A method of producing a crystal of an N-long-chain acylglycine salt, which comprises condensing glycine and a saturated or unsaturated fatty acid halide having 8-22 carbon atoms in a mixed solvent of a hydrophilic organic solvent and water with a hydrophilic organic solvent content of 5-30 wt %, in the presence of an alkali, at pH 9-13, then adjusting the N-long-chain acylglycine salt concentration in the reaction solution to 7-20 wt %, the hydrophilic organic solvent content to 3-75 wt %, and the pH to 7-11, and crystallizing an N-long-chain acylglycine salt from said reaction solution by cooling said reaction solution.
